(19) United States
(12) Patent Application Publication
(10) Pub. No.: US 2010/0147821 A1
(43) Pub. Date: Jun. 17, 2010

(54) Thermal deicer

(76) Inventors: Arthur D. Kaesler, Martinsville, NJ (US); Bryan A. Kaesler, Glen Gardner, NJ (US); Neville W. Richards, Hamilton, NJ (US); Matthew J. Richards, Hamilton, NJ (US)

Correspondence Address: Arthur D. Kaesler, 2085 Gilbride Road, Martinsville, NJ, 08836, US

(21) Appl. No.: 12/592,391

(22) Filed: Nov. 24, 2009

Related U.S. Application Data
(60) Provisional application No. 61/200,564, filed on Dec. 1, 2008.

(51) Int. Cl. B60L 1/02

(52) U.S. Cl. 219/202

(57) ABSTRACT

A heating element employs electrical resistance foils to provide a uniform heat that is used to prevent snow and ice from accumulating on the surfaces of vehicles.

### CROSS REFERENCE TO RELATED APPLICATION

This application claims the benefit of U.S. Provisional Patent Application No. 61/200,564, filed Dec. 1, 2008, and entitled Thermal Deicer, the entire disclosure of which is incorporated herein by reference.

### FIELD OF THE INVENTION

The present invention relates to electrically powered heating elements, and more particularly to heating elements used to supply heat to a vehicle surface to melt snow and ice.

### BACKGROUND OF THE INVENTION

During winter months, snow and ice buildups on vehicle surfaces cause various problems with performance and safety of those vehicles. This is especially true of tractor trailer trucks, where snow and ice build up on their roofs and other horizontal surfaces while these vehicles are parked. If this accumulated material is not removed, chunks of ice and snow can loosen and fall onto automobiles and other vehicles traveling behind the tractor trailers. The results can vary from minor damage to vehicles, to smashed windshields, accidents, and even possibly to deaths. While some truck stops have brushes or scrapers to help remove snow and ice build-up, these are not 100% successful—especially when an ice bond has formed on the metal surface of the vehicle. Such a bond is readily formed in freezing temperatures as the ice and snow negate most heat normally present in the tractor trailer roof's exterior surface.

### SUMMARY OF THE INVENTION

The heating element structure of the present invention employs electrical resistance foils to provide a heat source to a vehicle surface to raise that surface to a temperature sufficient to melt snow and ice, to thereby break the bond formed by the snow and ice with that surface. With respect to tractor trailer roofs, the present invention involves installing a heater on the inside of the trailer roof, thereby providing a heat sufficient to melt snow and ice. The heating system of the present invention is capable of operating while the tractor trailer is in a stationary position, as well as operating while the tractor trailer is in route to its destinations.

The present invention is not limited to truck roofs and to the safety issues discussed above. Other surfaces of vehicles for which accumulated snow or ice can result in safety or performance concerns can benefit from this invention. By way of examples, this invention is applicable to various surfaces on airplanes, construction vehicles, and military vehicles.

### BRIEF DESCRIPTION OF THE DRAWINGS

The following detailed description will be better understood when read in conjunction with the appended drawings, in which there is shown one or more of the multiple embodiments of the present disclosure. It should be understood, however, that the various embodiments of the present disclosure are not limited to the precise arrangements and instrumentalities shown in the drawings.

In the Drawings:

FIG. 1a is perspective bottom surface view showing the overall appearance of the heating elements located in a section of the roof of a trailer, according to one embodiment of the invention;

FIG. 1b is a partially cut-away view of the embodiment of the invention depicted in FIG. 1a;

FIG. 2 is a perspective bottom surface view showing the overall appearance of the heating mats positioned in a trailer roof in a manner that creates two stages or zones;

FIG. 3 depicts a typical heating element pattern layout according to a further embodiment of the invention;

FIG. 4a and FIG. 4b illustrate additional embodiments of the invention depicting means for protecting the heating sections on the inside roof of a trailer;

FIGS. 5a and 5b are schematic diagrams related to an embodiment of the invention;

FIGS. 6a-d depict various views of a control box of the heating element circuitry for one embodiment of the invention; and,

FIG. 7 is a cross sectional view of the heating element and related layers according to one embodiment of the invention.

### DETAILED DESCRIPTION

Certain terminology is used herein for convenience only and is not to be taken as a limitation on the embodiments of the present disclosure. In the drawings, the same reference letters are employed for designating the same elements throughout the several figures.

The present invention is an electrically powered heating system capable of sufficient heat for use in the melting of ice and snow. In one embodiment of the invention, the system is essentially a low-watt density electrically resistive heater, thermostatically controlled, that can be powered from a generator or a 120 volt plug-in power source. In a further embodiment of the invention, for use in a truck trailer, the generator can be mounted on either the truck cab or the trailer itself. The heating system is designed in such a way that the heating elements employed are flexible and moisture proof as to prevent various types of failure.

In an embodiment for use on a surface such as a truck trailer, the actual heating element is a stamped foil approximately 1 Mil thick, custom designed in a way that the stamped pattern produces an ohmic value of 30 Ohms per 20″×93″ section. This allows for a low watt density heat to be directly applied to the underside of the roof to maintain a level of warmth to keep the trailer roof sufficiently warm to melt ice and snow but not excessively hot to waste energy or to cause damage to the roof structure. The stamped foil heating element can be cupro-nickel, nickel chrome, aluminum, or any electrically conductive material in a flat foil form. A further embodiment of the invention has the heating elements laminated onto a clear plastic or Mylar sheet to produce an evenly heated waterproof and moisture-proof heater.

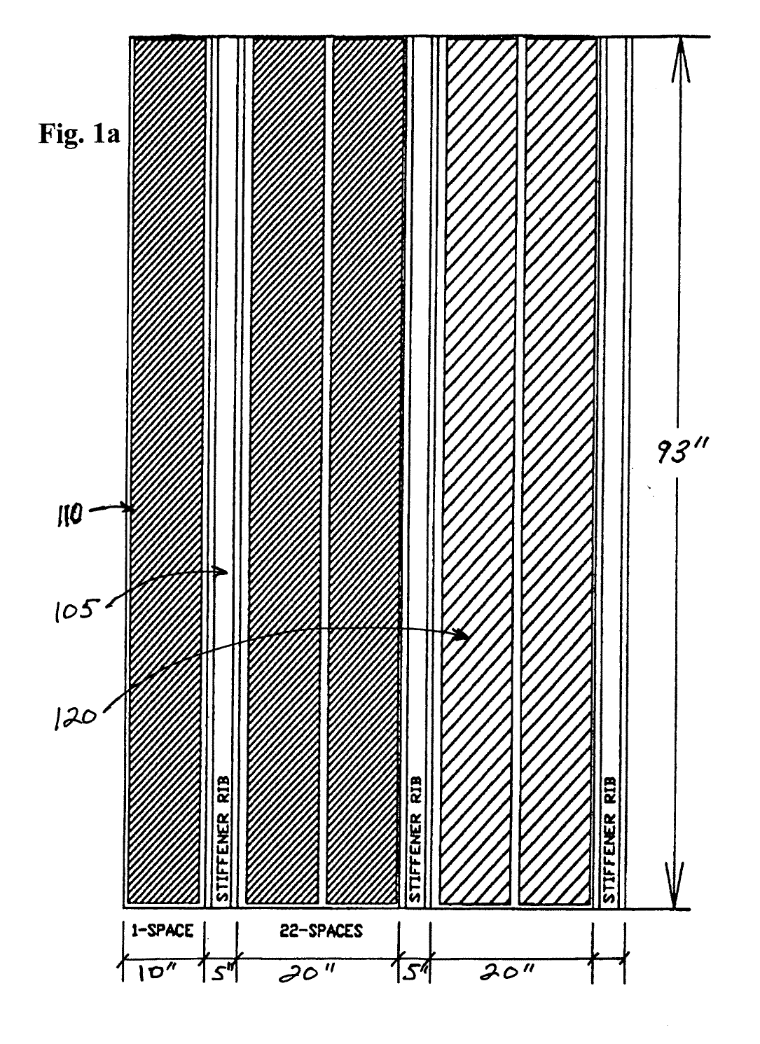

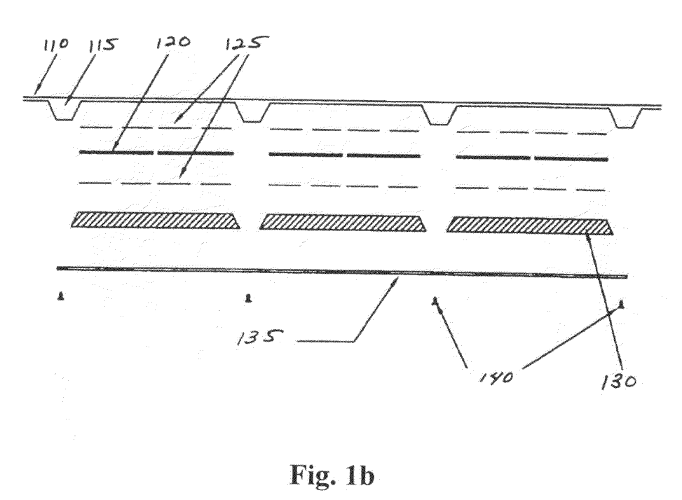

FIG. 1a is a perspective bottom surface view showing the overall appearance of the heating elements located in a section of the roof 110 of a trailer. As is well-known and illustrated in FIG. 1a, such trailers typically contain stiffener ribs 115 approximately every 25″ on center, commencing at 10″ from the end of the trailer. As illustrated, heating sections or mats 120, each approximately 10″ wide, are positioned in the gaps between these ribs 115, with two mats 120 positioned in each of the 20″ wide gaps. Each of the mats runs the approximate interior width of the trailer, which is indicated as being 93″ in the figure. The invention is not limited to these dimensions as it is envisioned that alternative embodiments of the invention would be capable of being employed in various size trailers (e.g., narrow, wider, longer) as well as various other types of vehicles.

FIG. 1b is a partially cut-away view of the trailer embodiment depicted in FIG. 1a. As illustrated, the mat heaters 120 are attached to the underside of the trailer roof 110 by high-temperature double sided tape 125. High-temperature double sided tape 125 is also used to secure an insulation layer 130, approximately 1″ thick in this particular embodiment, to the underside of the mat heaters 120. In a further embodiment, an overlay protector 135 is then fastened to the underside of the insulation (e.g., by stainless screws 140 in this embodiment) to prevent damage to the heating structure.

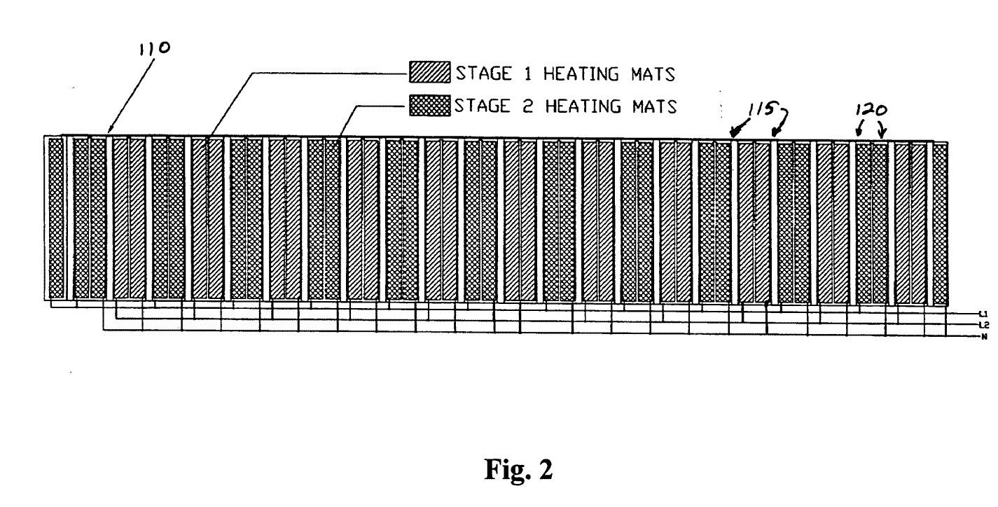

FIG. 2 is a perspective bottom surface view showing the overall appearance of the heating mats positioned in a trailer roof 110 in a manner that creates two zones, Stage 1 and Stage 2. As illustrated and as previously described above, heating mats 120 run the approximate entire width of the trailer in the spaces between the trailer ribs 115, with a pair of mats 120 positioned in each of the 20″ wide gaps. As indicated by lines L1, L2, and N, these mats are electrically connected in two stages. These stages, Stage 1 and Stage 2, work off of a timer (not shown). Thus in operation, Stage 2 heater elements will be in an OFF state while Stage 1 heater elements are in an ON state, and vice versa. In one embodiment of the invention, this switching between stages occurs every 10 minutes. Each pair of low-watt density heater mats 120 produces 480 watts on 120 volts. Thus for the trailer embodiment depicted in FIG. 2, the Stage 1 heating sub-system, comprising 11 pairs of heater mats 120, will produce 5280 watts; and the Stage 2 heating sub-system, comprising 12 pairs of heater mats 120, will produce 5760 watts. With this structure and a timer cycling between the two stages, the system is capable of being run off either a 120 volt supply while at a truck stop, or off a 7.5 KW generator mounted on the vehicle (tractor or trailer) during driving times.

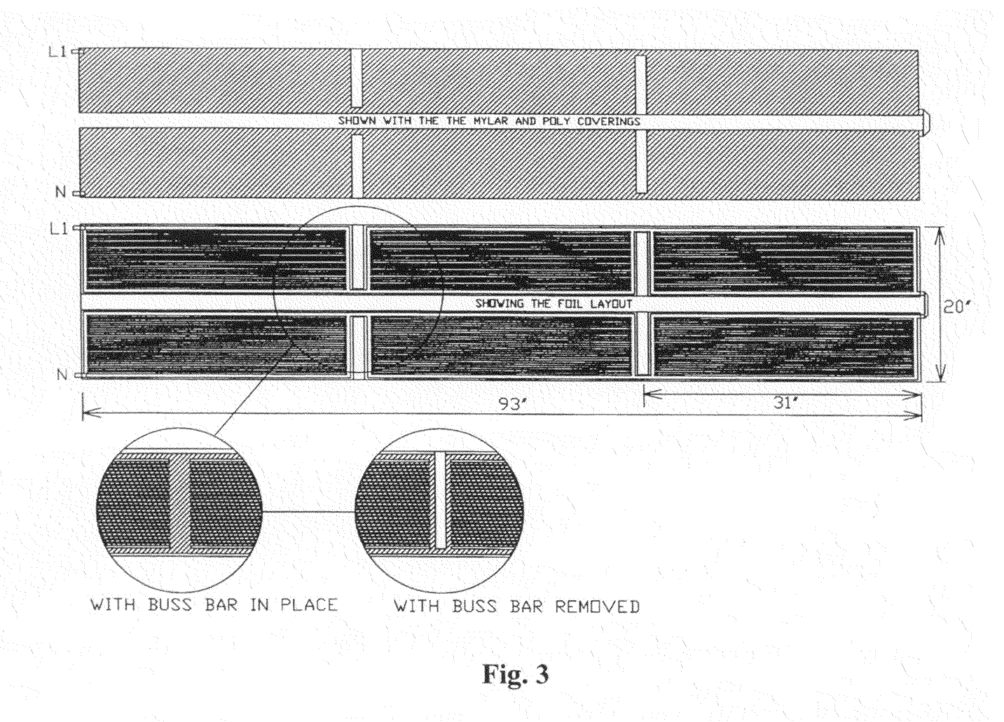

FIG. 3 depicts a heating element pattern layout according to a further embodiment of the invention. In particular, FIG. 3 illustrates the sectioning of pairs of heating mats 120 into three sections width-wise and the use of buss bars to maintain the proper wattage. In particular, by cutting away the buss bar, the heating elements are changed from parallel to series to obtain the desired wattage, i.e. 480 watts on 120 volts.

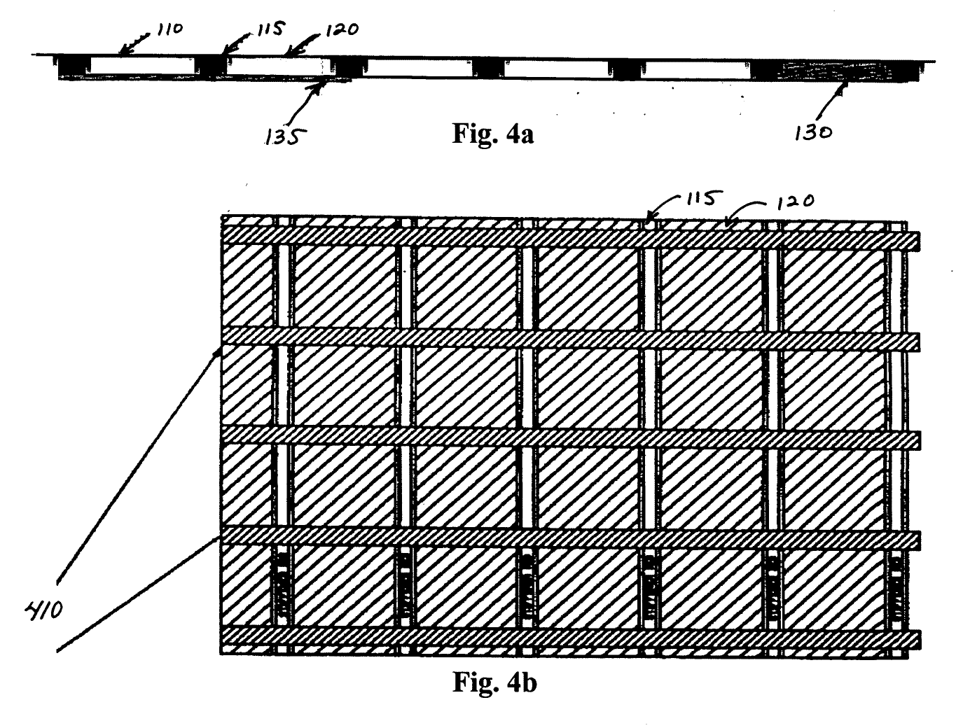

FIGS. 4a and 4b illustrate additional embodiments of the invention depicting means for protecting the heating sections on the inside roof 110 of a trailer. In particular, ⅜″ or ½ ″ plywood, aluminum or stainless overlay, or plastic overlay protectors can be used as the overlay protector 135 illustrated in FIG. 4a. FIG. 4b depicts further embodiments in which strips 410, running lengthwise down the trailer, are utilized as various additional means for providing protection to the heating sections. These strips 410 can be made from various materials, to include, aluminum, stainless steel, or wood.

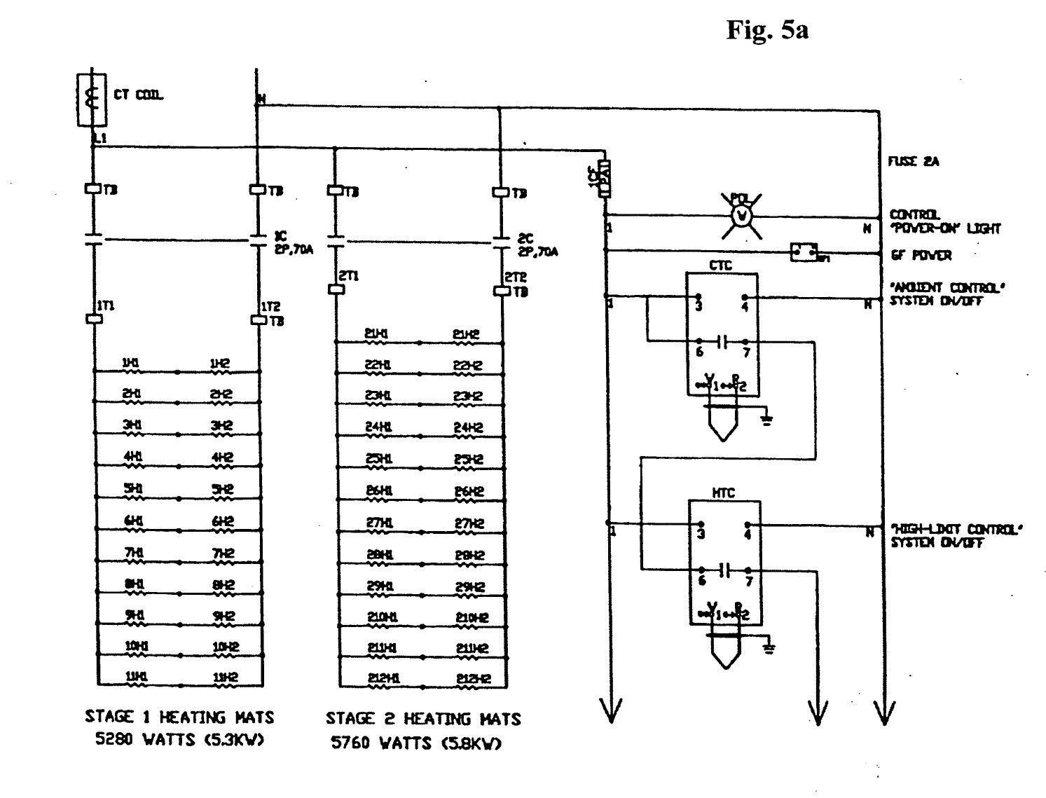

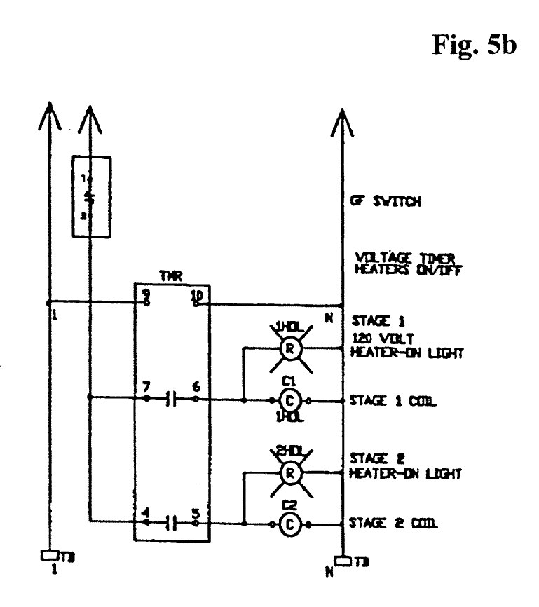

FIG. 5 is a schematic diagram of an embodiment of the invention. As illustrated, the system employs a non-reversing contactor with 120V coil. As illustrated and as described previously above, this invention employs pairs of heating mats (e.g., 1H1 and 1H2) arranged in two stages. Only one stage is energized at a given time. With this arrangement, the maximum wattage (i.e., the stage 2 heating mats) required is 5760 watts. Accordingly, the system will run off either a 120 volt supply at the dock or it can run off a 7.5 KW generator mounted on the truck.

The schematic diagrams of FIGS. 5a and 5b illustrate various additional features of this embodiment of the invention. These include GF protection and use of shut off switches which trigger when the ambient temperature is above a settable threshold (e.g., 50° F.) or when the heating element has exceeded a settable threshold (e.g., 110° F.).

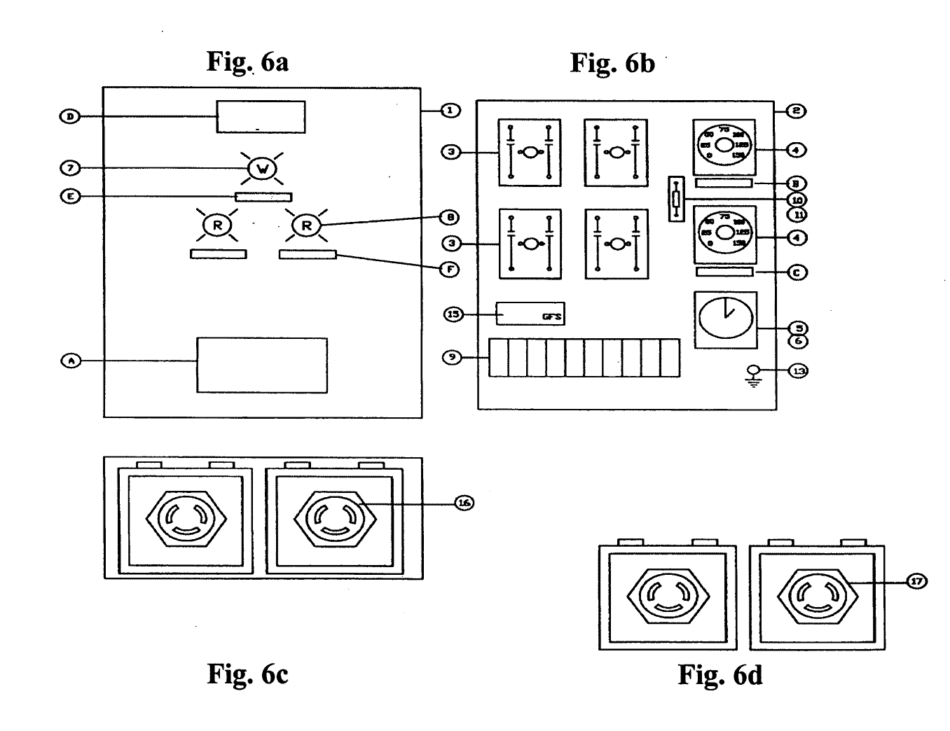

FIGS. 6a-d depict various views of a control box of the heating element circuitry according to an embodiment of the invention. In particular, FIG. 6a depicts the hinge cover, while FIG. 6b depicts the back panel. Various lights, terminals, connections and functional elements are illustrated in FIGS. 6a-d, and identified in the following tables:

BILL OF MATERIALS

| ITEM | QTY. | MANUFACTURER & DESCRIPTION | PART# |
|---|---|---|---|
| 1 | 1 | HOFFMAN JUNCTION BOX, NEMA 4X, STAINLESS | A-1614CHNF |
| | | STEEL, 14″ × 12″ × 6″, HINGE COVER | |
| 2 | 1 | HOFFMAN BACK PANEL, STEEL | A-12P10 |
| 3 | 4 | S&S CONTACTORS, 2-POLE, 70AMP RATED WITH | D3P75A120 |
| | | A 120 VOLT COIL NON-REVERSING | |
| 4 | 2 | PAK-STAT ELECTRONIC THERMOSTAT, | P-14A0318 |
| | | 0-150 DEG. F. 1-S.P.S.T. 15 AMP SWITCH | |
| 5 | 1 | FUJI ELECTRONIC TEMPERATURE TIMER WITH | MS4SH-AP- |
| | | MANUAL ADJUSTMENT, DUAL RELAY CUTOUT, | ADC |
| | | DUAL RELAY OUTPUT | |
| 6 | 1 | FUKI SOCKETS, 11-PIN, TERMINALS ON FRONT | TP411X |
| 7 | 1 | LOVATO LED PILOT LIGHTS, 120 VOLT, “WHITE” | 8 LP2T 1LE8 |
| 8 | 2 | LOVATO LED PILOT LIGHTS, 120 VOLT, “RED | 8 LP2T 1LE4 |
| 9 | 10 | MARATHON TERMINAL BLOCKS, 60 AMP, 600 | 6G38 TS DIN |
| | | VOLT RATED, BOX TYPE | |
| 10 | 1 | BUSSMAN FUSE HOLDER, 1-POLE, 30A, 250 V | S-8301-1 |
| 11 | 1 | BUSSMAN FUSE, 1-AMP, 250VAC | ABC2 |
| 12 | 2 | WIRING, LUGS, LABELS, RING LUGS, ETC. | A/R |
| 13 | 2 | GROUND LUGS | TAG-1 |
| 14 | 2 | THERMOCOUPLE, TYPE “J”, 4″ PROBE WITH | MI-J-4-120 |
| | | 10 FT. STAINLESS STEEL BRAIDED LEAD | |
| 15 | 2 | GROUND FAULT-SHUNT TRIP RELAY, | AGI-NOAC- |
| | | 30MA, 120VAC | 120 |
| 16 | 2 | MARINCO PANEL MOUNTED WEATHER TIGHT | 301ELRV |
| | | 120 VOLT CONNECTORS SERIESED TOGETHER | |
| | | LOCATED ON THE CONROL BOX FOR 120 VOLT | |
| | | GENERATOR HOOK-UP | |
| 17 | 2 | MARINCO PANEL MOUNTED WEATHER TIGHT | 301ELRV |
| | | 120 VOLT CONNECTORS SERIESED TOGETHER | |

NAME PLATE BILL OF MATERIALS

| REF | DESCRIPTION | SIZE | COLOR |
|---|---|---|---|
| A | THERMAL DE-ICER | 4 × 1½ | WHITE |
| | ROOF HEATING SYSTEM | | |
| B | PROCESS CONTROL | 2½ × ¾ | WHITE |
| C | HEATER HIGH-LIMIT | 2½ × ¾ | WHITE |
| D | HOTFOIL - EHS INC. | 3 × 2 | WHITE |
| | 2960 EAST STATE STREET EXT. | | |
| | HAMILTON, NJ 08619 | | |
| | 609-588-0900 | | |
| E | POWER-ON LIGHT | 2 × ⅝ | WHITE |
| F | HEATER-ON LIGHT | 2 × ⅝ | WHITE |

It should be noted that FIG. 6c illustrates weather tight 120 volt connectors 16 located on the control box 2 itself. FIG. 6d shows a further embodiment of the invention whereby 120 volt connectors 17 are separate from the control box 2 (e.g., are located on the rear of the trailer).

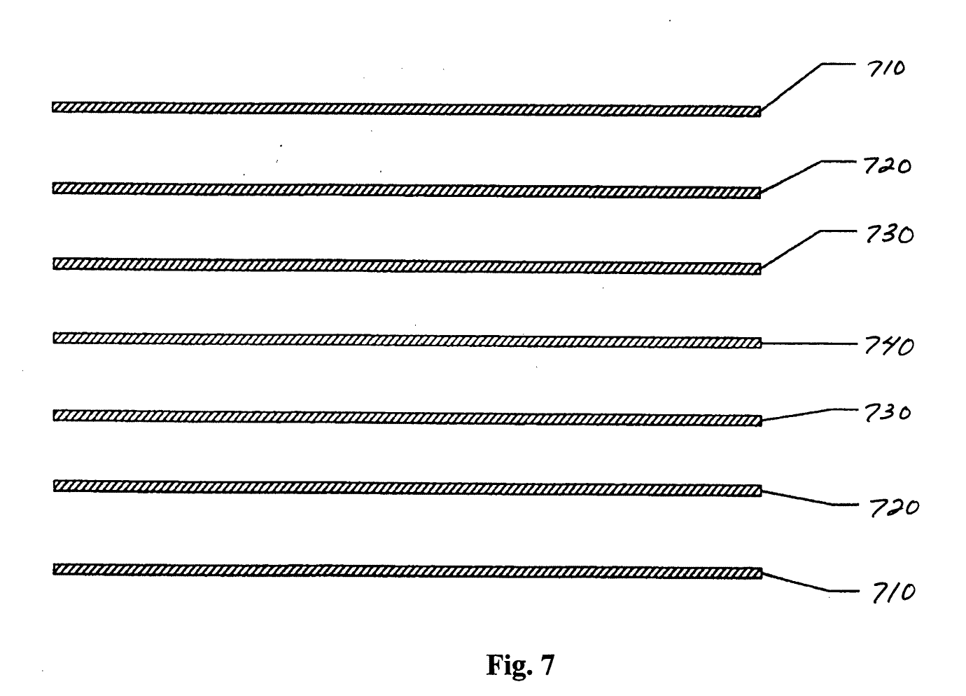

FIG. 7 depicts layers used in the construction of the heating mat according to one embodiment of the invention. In this embodiment, aluminum foil approximately 1 Mil thick is used as the heating element 740. This foil 740 is encapsulated into a pressure sensitive nylon coating 730 that is 0.5-1.0 Mil thick that is then used to bond the nylon carrier to a polyester carrier layers 720, each not less than 4 Mil thick. This polyester carrier 720 is self-adhesive and allows the two carriers 720 to essentially become one structure. Self adhesive coatings 710 are then applied to the top and bottom of the structure, the coatings each being no less than 0.5 Mil thick and having dual adhering sides. At the top of the resulting structure, the respective adhesive coating will bond directly to the vehicle surface to be heated (e.g., a trailer roof 110). At the bottom of the resulting structure, the respective adhesive coating will bond to an insulation layer (e.g., layer 130). In the construction process, once the layers are arranged in the above manner, the structure is slightly heated and then rolled together to remove most air trapped between the layers and also to seal the layers together.

It should be noted that the control embodiments of the present disclosure may be implemented with any combination of hardware and software. If implemented as a computer-implemented apparatus, the present disclosure is implemented using means for performing all of the steps and functions described above.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of the present disclosure is not limited to the particular examples and implementations disclosed herein, but is intended to cover modifications within the spirit and scope thereof as defined by the appended claims and any and all equivalents thereof.

What is claimed is:

1. A system for generating heat sufficient for melting ice and snow from an outer surface of a vehicle, the vehicle having a corresponding inner surface, the system comprising:
a plurality of heating elements, each comprising electrical resistive foil and each heating element positioned near the inner surface of the vehicle; and,
an electrical circuit providing power to the plurality of heating elements.

2. The system of claim 1 wherein the plurality of heating elements are arranged in two zones, each heating element being in only one zone; and wherein the electrical circuit provides power alternately to each zone.

3. The system of claim 1 wherein the electrical circuit comprises a GFI component.

4. The system of claim 1 wherein the electrical circuit comprises an ambient temperature shutoff switch which triggers when the ambient temperature is above a settable threshold.

5. The system of claim 1 wherein the electrical circuit comprises a high-limit shutoff switch which triggers when the system generates heat in excess of a settable threshold.

6. The system of claim 1 wherein the each of the plurality of heating elements comprises;
a stamped foil element having a top side and a bottom side;
two pressure sensitive nylon coating layers, the first positioned adjacent to the top side of the stamped foil element, the second positioned adjacent to the bottom side of the stamped foil element;
two polyester carrier layers, the first positioned adjacent to the first pressure sensitive nylon coating layer, the second positioned adjacent to the second pressure sensitive nylon coating layer; and,
a self adhesive coating layer applied to each of the two polyester carrier layers.

7. The system of claim 6 wherein the resulting heating element structure is flexible.

8. The system of claim 1 wherein the vehicle is a truck trailer and the plurality of heating elements are positioned on the inside of the trailer roof.

9. The system of claim 8 wherein each of the plurality of heating elements are positioned in spaces between stiffener ribs of the trailer roof.

10. The system of claim 9 further comprising:
a layer of high-temperature double sided tape to secure the heating elements to the trailer roof;
a layer of high-temperature double sided tape to attach insulation to the heating elements;
an overlay protector to cover at least part of the insulation layer for protection from damage.

11. The system of claim 9 wherein two heating elements are positioned in each space between stiffener ribs and each heating element substantially spans the entire interior width of the trailer.

12. The system of claim 9 wherein six heating elements are positioned in each space between stiffener ribs and each heating elements spans approximately ⅓ the interior width of the trailer.

13. The system of claim 9 wherein the power can be provided off either a 120 volt supply external to the trailer or off a 7.5 KW generator mounted on the vehicle.

14. A method for generating heat sufficient for melting ice and snow from an outer surface of a vehicle, the vehicle having a corresponding inner surface, the method comprising:
positioning near the inner surface of the vehicle a plurality of heating elements, each comprising electrical resistive foil; and,
providing power to the plurality of heating elements using an electrical circuit.

15. The method of claim 14 further comprising:
arranging the plurality of heating elements into two zones, each heating element being in only one zone; and,
providing power alternately to each zone.

16. The method of claim 14 wherein the vehicle is a truck trailer and said positioning step comprises positioning the heating elements on the inside of the trailer roof.

17. The method of claim 14 wherein said positioning step comprises positioning each of the plurality of heating elements in spaces between stiffener ribs of the trailer roof.

18. The method of claim 17 further comprising:
utilizing a layer of high-temperature double sided tape to secure the heating elements to the trailer roof;
utilizing a layer of high-temperature double sided tape to attach insulation to the heating elements;
utilizing an overlay protector to cover at least part of the insulation layer for protection from damage.

19. The method of claim 14 further comprising:
positioning two heating elements in each space between stiffener ribs whereby each heating element substantially spans the entire interior width of the trailer.

20. The method of claim 14 further comprising:
positioning six heating elements in each space between stiffener ribs and whereby each heating elements spans approximately ⅓ the interior width of the trailer.
